(19) United States
(12) Patent Application Publication
(10) Pub. No.: US 2003/0204988 A1
(43) Pub. Date: Nov. 6, 2003

(54) Process for propagation and utilization of mimosa

(76) Inventors: David I. Bransby, Auburn, AL (US); Steve R. Duke, Auburn, AL (US); Gopal A. Krishnagopalan, Auburn, AL (US)

Correspondence Address: JONDLE & ASSOCIATES P.C., 9085 EAST MINERAL CIRCLE, SUITE 200, CENTENNIAL, CO, 80112, US

(21) Appl. No.: 10/089,518

(22) PCT Filed: Jun. 1, 2001
(86) PCT No.: PCT/US01/17888

(51) Int. Cl. A01C 1/00; A01B 79/02; A23K 1/00

(52) U.S. Cl. 47/58.1 R; 426/635

(57) ABSTRACT

This invention provides a process for propagation of mimosa (Albizia julibrissin) and utilization of this plant species as forage for livestock, in food plots for deer, as a source of raw material for pulp and paper production, production of composite materials, and as a source of biomass for production of bioenergy.

### CROSS REFERENCE

This application is related to U.S. provisional application, serial No. 60/209,334 filed Jun. 2, 2000, incorporated by reference herein.

### FIELD OF INVENTION

This invention provides a process for propagation of mimosa (Albizia julibrissin) and utilization of this plant species as forage for livestock, in food plots for deer, as a source of raw material for pulp and paper production, production of composite materials, and as a source of biomass for production of bioenergy.

### BACKGROUND

Forage for Livestock and Deer

In order to ensure optimal animal growth and reproduction, deer and livestock need large quantities of high quality feed. This is commonly provided by planting pastures for livestock, and food plots for deer. Plant species that are commonly propagated for these purposes are herbaceous or non-woody in nature. Examples of these species are grasses and pasture legumes, such as clover. However, these forage crops have the following disadvantages.

1) They grow in a canopy close to the ground, and therefore, much of the forage they produce is wasted because it is trampled on by livestock while they are grazing, and fouled with their excreta. Typically, only about 50% of the forage produced in such pastures is consumed by grazing animals, and the other half is wasted.

2) Pasture canopies that are close to the ground offer favorable environments for the larvae of internal parasites (stomach worms). Therefore, animals grazing these pastures have a high tendency to become infected with these parasites, with a resultant reduction in animal production, and an increased expense in having to treat the animals with anthelmintic chemotherapy.

3) Many warm season grasses are low in quality, especially in late summer and autumn, and legumes tend to die out at this time. Low protein is the most limiting factor for deer growth and antler size: these animals require an average of about 17% crude protein in their diet for optimal growth and development. However, the crude protein of most of the species commonly used for forage for deer and livestock is considerably lower than this, especially in late summer and autumn.

4) Even though legumes may be high in quality, they are typically unable to compete with grasses in a grass/legume mixture.

5) In order to ensure high forage yields, forages need fertilization: grasses need to be fertilized with nitrogen, phosphorus and potassium, while legumes such as alfalfa have a high demand for phosphorus and potassium.

6) In order to ensure that legumes such as clover and alfalfa nodulate and symbiotically fix nitrogen from the air in the soil, it is necessary to inoculate the seed with rhizobium bacteria before planting.

7) For some forage crops there is no commercial herbicide available that will selectively control weeds without damaging the crop. This makes establishment if the crop extremely difficult.

Tree Crops for Production of Pulp and Paper, Composite Materials and Bioenergy

About 90% of the paper produced globally is produced from wood. For the USA this figure is about 99%. Softwoods, such as conifers (like pine trees), provide long fibers (3-5 mm) that are commonly used to produce newsprint and cardboard. However, the short fibers (0.7-2.0 mm) obtained from hardwoods (such as sycamore, sweet gum, poplar and oak) are required to make the high quality fine papers needed for copy machines and computer printers. Unfortunately, in the USA, although pines are now being grown in plantations, very few hardwood species are being propagated. This means that the supply of hardwood fiber is dependent mainly on natural regeneration of clearcut forests, and this usually takes 30-60 years. The demand for the fine paper which requires hardwood fiber (and, therefore, the demand for hardwoods) is increasing more rapidly than any for any other category because of the increased use of computers and copiers. Consequently, it is expected that hardwood resources will be subject to extreme pressure over the next few decades.

In addition to production of pulp and paper, trees can also be used for production of composite materials and panels, such as particle board and oriented strand board, and biomass to produce bioenergy, such as ethanol and electricity. As for the production of pulp and paper, a high yield of wood per acre per year, and low inputs, are necessary to minimize the cost of producing the raw material. Woody crops under intensive development for this purpose are hybrid poplar (Populus spp) and various willow (Salix) species. Tree species currently used to supply raw woody material for bioenergy or production of pulp and paper have the following disadvantages.

1) Yields are generally low (3-5 tons of dry biomass/acre/year for naturally regenerated stands, and 5-7 tons/acre/year for plantation grown poplar and willow).

2) Stands can only be harvested very infrequently (every 30-60 years for natural stands, and every 4-10 years for willow and poplar, respectively): more frequent harvesting usually results in substantially reduced yields, and in the case of some species, death, because trees are generally not adapted to frequent cutting.

3) There is a long delay from planting or clearcutting to the next harvest, and this can cause cash flow problems for the grower.

4) Most hardwoods that can be grown in plantations, like poplar and willow are not legumes, and therefore need nitrogen, phosphorus and potassium pertilizer at establishment.

5) Most hardwoods cannot be successfully planted with seed. This means they need to be planted with cuttings which requires special equipment and increases the cost.

6) Trees currently used for pulp and paper or bioenergy have little or no value as forage for livestock and deer.

Mimosa was introduced to the USA over 200 years ago. It is used only as an ornamental shade tree, and has not been studied for use in other applications, except for medicinal use in Asia. Mimosa is a leguminous plant that has become naturalized in the southeastern USA, but it grows throughout the tropical, sub-tropical and mild temperate regions of the world.

### SUMMARY OF THE INVENTION

The present invention provides a method for the propagation of mimosa, and using mimosa as forage for livestock and deer, and/or for production of bioenergy, composite materials or panels, pulp and paper. The process involves planting mimosa by seed, allowing deer and/or livestock access to the foliage for feed, and/or harvesting the wood for production of biomass to produce bioenergy, pulp and paper/cardboard, or composite panels.

In another embodiment of the present invention, for large scale commercial fields mimosa seed is planted with regular row crop planters. The seed has a hard seed coat which prevents germination unless it is scarified. Therefore, prior to planting, the seed preferably is scarified, such as with hot water or mechanical scarification. The seed may or may not be inoculated with rhizobium bacteria: generally, inoculation is not necessary for nodulation to occur. Fertilization is generally not necessary, but weed control usually enhances rate of establishment. This is done by several means, including use of herbicides such as Strongarm and Pursuit.

Field establishment of mimosa deer food plots are problematic in the presence of high deer populations, because deer tend to feed on the young mimosa seedlings too much, resulting in serious stunting or death. In one embodiment of the present invention, mimosa is first established in pots, some other containers, or in a field protected from deer. Once the plants are above the feeding height of deer, they are transplanted into the food plots and pruned as needed. To allow optimal use of mimosa by deer in food plots, it is best to keep the plants pruned periodically so that the foliage remains within easy reach of the animals (preferably less than 4 ft above ground level). Mimosa provides greater quantities of higher quality forage than other plant species used for this purpose.

In one embodiment of the present invention, the controlled use of mimosa as forage for livestock (such as cattle, sheep and goats) involves rotational stocking, allowing animals periodic access to it in order to consume part or all of the foliage every few weeks. Livestock are allowed continuous access to the mimosa if the stocking rate is low. Alternatively, mimosa is used as a fodder bank, cutting it down to a height of about 6 to 12 inches, and allowing new shoots and branches (coppice growth) to develop from the stumps until the forage is needed. At that time, livestock are allowed access to it. Even if the coppice is tall (over 10 ft), cattle reach the foliage by pushing these branches down, provided they are not too thick. Therefore, it is not necessary to keep the growth pruned to within easy reach of the animals. Furthermore, the limbs generally do not break when pushed down, over 90% of the forage is consumed because virtually none of it is trampled or fouled, and the exposure to internal parasites is reduced. Finally, once again, greater quantities of forage with higher quality are produced by mimosa than by other forages, and the plant is adapted to a wide range in soil conditions, extremely resistant to insect pests, and very tolerant of drought.

In another embodiment of the present invention, whether foliage in mimosa fields is used for forage or not, the wood is used for production of pulp and paper, bioenergy or composite panels. If mimosa is to be used for both forage and wood, then it needs to be cut annually. However, wood yield/year is generally higher if it is cut every 2 to 3 years. When using it for forage and wood, after animals have removed the foliage, wood is cut by hand or mechanically. If animals are not part of the system, the wood is cut at any time. It is then processed into chips, flakes, or some other particulate format before being used to produce pulp and paper, composite panels or bioenergy.

To produce pulp and paper, mimosa is used as a conventional hardwood substitute, because it has similar fiber properties to common hardwood species. Therefore, it is useful in the production of fine quality paper. Mimosa wood is chipped and fed into existing pulp mills to produce pulp. It is either used alone, or mixed with other hardwood or softwood material, before or after pulping. When used alone, mimosa requires less energy and less chemicals to pulp than typical hardwoods, and less bleach to obtain equivalent brightness.

Major advantages of this invention include the following:

1) Low-cost establishment with seed.

2) Generally, no need to inoculate seed with rhizobium in order to ensure nodulation and nitrogen fixation.

3) Generally, no need to fertilize.

4) Production of large yields of high quality forage.

5) Production of high yields of wood, even with frequent harvesting, such as every year.

6) Strong perenniality.

7) High tolerance to insect pests.

8) Wide adaptation to soil conditions.

9) High tolerance to drought.

10) Reduced energy requirement for pulping.

11) Reduced chemical requirement for pulping.

12) Reduced bleaching requirement for paper making.

13) Potential for multiple uses (forage and industrial raw material) in the same system.

### DEFINITIONS

In the description and tables which follow, a number of terms are used. In order to provide a clear and consistent understanding of the specification and claims, including the scope to be given such terms, the following definitions are provided:

Food plots—As used herein, the term “food plots” refer to small plots (usually up to one or two acres) on which plants are established to provide high quality forage for free ranging, wild deer. The objective of food plots is to provide a high quality diet for wild deer, in order to optimize body and antler growth; and reproduction, and to attract deer to a particular location for hunting purposes.

Stocking rate—As used herein, the term “stocking rate” refers to the number of animals of specified size and species, per unit area of land, for a specified period of time.

Feeding height—As used herein, the term “feeding height” is defined as the maximum height from which a particular animal species will consume forage. For wild whitetail deer, this is usually 3 to 4 feet above ground level.

Kappa number—As used herein, the term “kappa number” refers to the volume in milliliters of 0.1 N potassium permanganate solution consumed by one gram of moisture free pulp under the conditions specified in Tappi (Technical Association of the Pulp and Paper Industry) standard T236. Kappa number is proportional to the lignin content of pulp. Indicates the relative hardness, bleachability or degree of delignification of pulp.

Viscosity of Pulp—As used herein, the term “viscosity of pulp” is measured as (solution) viscosity of 0.5% cellulose (pulp) solution, using 0.5 Molar cupriethlenediamine as a solvent and a capillary viscometer as per Tappi (Technical Association of the Pulp and Paper Industry) standard T230. The solution viscosity of a pulp gives an indication of the average degree of polymerization of the cellulose. Gives a relative indication of the degradation (decrease in the degree of polymerization or molecular weight) resulting from the pulping process.

Beater curve—As used herein, the term “beater curve” refers to a process of subjecting the pulp to controlled mechanical treatment in a specially designed equipment called “laboratory beater” as per Tappi (Technical Association of the Pulp and Paper Industry) standard T200. A measured amount of pulp of specified concentration is beaten (process of subjecting to above-mentioned treatment) between the roll and bedplate of a beater. Samples are withdrawn at regular intervals during treatment to determine beating degree and be made into laboratory handsheets for evaluation of strength properties. Degree of beating is determined by freeness (Canadian Standard Freeness) as per Tappi (Technical Association of the Pulp and Paper Industry) standard T227. Hand sheets for evaluating strength properties are prepared in specially designed equipment and specified method according to Tappi (Technical Association of the Pulp and Paper Industry) standard T205.

TAPPI standard handsheets—As used herein, the term “TAPPI standard handsheets” refers to paper made according to Tappi standard 205 which provides a precise standard procedure for making test sheets from pulp that ensures a high degree of reproducibility.

Freeness levels—“Freeness” of pulp gives a measure of the rate at which a dilute suspension of pulp (3 grams of pulp in liter of water) may be drained using specially designed equipment according to Tappi standard 227. It is widely used to follow the changes in the drainage rate of chemical pulps during beating (as the pulp is beaten the drainage rate reduces).

Bursting strength—“Bursting strength” is defined as the hydrostatic pressure in kilopascals, or pounds per square inch or psi, required to produce rupture of the paper when the pressure is increased at a controlled rate through rubber diaphragm to a circular area, 30.5-mm diameter. The area of the paper under test is initially flat and held rigidly at the circumference but is free to bulge during the test. Test performed in equipment and procedure as specified in Tappi standard T 403. Burst index is the bursting strength in kilopascal divided by the grammage grammage (grams per square meter) of the test specimen.

Tensile strength—“Tensile strength” is the maximum tensile stress developed in a test specimen before rupture on a tensile test carried to rupture under prescribed conditions as specified in Tappi standard T 494. Tensile strength is the force per unit width of test specimen. Tensile index is defined as tensile strength in N/m divided by grammage (grams per square meter) of the test specimen.

Fibers—“Fibers” refer to cellulose containing material derived from wood.

Pulp—refers to fibrous raw material used for example paper making.

Hardwood—wood from broad leafed angiosperms. Mimosa is a tropical hardwood.

Paper—felted sheet formed on a fine screen from a water suspension of fibers.

Lignin—material which holds or cements fibers together in wood.

Biomass—the material produced by the growth of microorganisms, plants, or animals, especially as a product of or raw material for an industrial process.

Chemical pulping—the removal of lignin by use of chemicals in order to liberate the cellulosic fibers from the structural matrix of wood.

Mechanical pulping—use of mechanical means, for example grinding, to liberate fibers from wood.

### BRIEF DESCRIPTION OF DRAWINGS

The above and other features and advantages of the invention will become apparent from a consideration of the ensuing description of its various embodiments considered in conjunction with the accompanying drawings, in which:

FIG. 1 is a graphical illustration of beater curves for one-year-old mimosa and sweet gum;

FIG. 2 is a graphical illustration of beater curves for two-year-old mimosa and sweet gum;

FIG. 3 is a graphical representation of burst strength at different freeness levels for one-year-old mimosa and sweet gum;

FIG. 4 is a graphical representation of burst index for two-year-old mimosa alone or blended with softwood;

FIG. 5 is tensile strength of one-year-old mimosa and sweet gum at different freeness levels; and

FIG. 6 is a graphical representation of tensile index for two-year-old mimosa alone or blended with softwood.

### DETAILED DESCRIPTION OF THE INVENTION

The present invention provides a process for propagation of mimosa, and using the mimosa as a forage for livestock and deer, and/or for production of bioenergy, composite materials or panels, and pulp and paper. The process involves planting mimosa by seed, allowing deer and/or livestock access to the foliage for feed, and/or harvesting the wood for production of biomass to produce bioenergy, pulp and paper/cardboard, or composite panels.

For large scale commercial fields, mimosa seed is planted with regular row crop planters. Typically, a planter seed plate suitable for planting sorghum or small grains is used, because the size of mimosa seed is similar to the size of the seeds of these crops. Mimosa seed has a hard seed coat which prevents germination unless it is scarified. Therefore, prior to planting, the seed needs to be scarified, such as with hot water or mechanical scarification. Hot water scarification involves bringing a pot of water to boiling point, removing it from the heat source and placing the seed in the hot water for about 4 minutes. The water is then poured off the seed which is spread out and allowed to dry prior to planting. Alternatively, mimosa seed is mechanically scarified by processing it through any physical device that will scratch the seed coat and facilitate penetration of water. Germination is usually increased by scarification from less than 5% prior to treatment, to over 90% following treatment.

The seed may or may not be inoculated with rhizobium bacteria: generally, inoculation is not necessary for nodulation to occur. This means that mimosa is a broad spectrum legume that nodulates readily with rhizobium bacteria which are naturally present in the soil. Fertilization is generally not necessary, but weed control usually enhances the rate of establishment. This is done by several means, including mechanical tillage or use of selective herbicides such as Strongarm and Pursuit. Depending on circumstances, mimosa is propagated from stem cuttings and tissue culture. Further options are to establish it by any of the above methods in pots or other containers, or in seedling beds or fields, and transplant young plants into the location/field where they are needed for production.

Field establishment of mimosa deer food plots are problematic in the presence of high deer populations, because deer tend to feed on the young mimosa seedlings too much, resulting in serious stunting or death. In such cases, mimosa can be first established in pots, some other containers, or in a field protected from deer. Once the plants are above the feeding height of deer, the plants are transplanted into the food plots and pruned as needed.

To allow optimal use of mimosa by deer in food plots, it is best to keep the plants pruned periodically so that the foliage remains within easy reach of the animals (preferably less than 4 ft above ground level). Plants should be spaced adequately for animals to move among them freely, and further apart if other species are to me grown among mimosa plants. Mimosa will provide greater quantities of higher quality forage than other plant species used for this purpose.

For use as forage for cattle, mimosa preferably is planted in rows about 6 ft apart to allow animals to enter the stand easily. It may be planted in many different configurations, including solid stands, or in strips and clumps within existing grass pastures.

Controlled use of mimosa as forage for livestock (such as cattle, sheep and goats) involves rotational stocking, allowing animals periodic access to it in order to consume part or all of the foliage every few weeks. Livestock are allowed continuous access to the mimosa if the stocking rate is low. Alternatively, mimosa is used as a fodder bank, cutting it down to a height of about 6 to 12 inches, and allowing new shoots and branches (coppice growth) to develop from the stumps until the forage is needed. If the wood is not required for some other use, this is done by means of a heavy duty mower or bushhog. After regrowth occurs, livestock are allowed access to it. Even if the coppice is tall (over 10 ft), cattle reach the foliage by pushing these branches down, provided they are not too thick. Therefore, it is not necessary to keep the growth pruned to within easy reach of the animals. Furthermore, the limbs generally do not break when pushed down, over 90% of the forage is consumed because virtually none of it is trampled or fouled, and the exposure to internal parasites is reduced because the forage is high above ground level where all the parasite larvae are located. Finally, once again, greater quantities of forage with higher quality are produced by mimosa than by other forages, and the plant is adapted to a wide range in soil conditions, is extremely resistant to insect pests, and very tolerant of drought.

Mimosa is used to make silage. If used for this purpose, it is harvested mechanically with an implement such as a forage chopper when the growth is still relatively young and tender. Provided this material is well compressed and oxygen is excluded, high quality silage is produced without the use of silage additives. Alternatively, mimosa can be dried naturally or in driers following harvesting, and fed to livestock as a dry feed.

Whether foliage in mimosa fields is used for forage or not, the wood is subsequently used for production of pulp and paper, bioenergy or composite panels. If mimosa is to be used for both forage and wood, then it needs to be cut annually. However, wood yield/year is generally higher if it is cut every 2 to 3 years. When using it for forage and wood, after animals have removed the foliage, wood is cut by hand or mechanically. If animals are not part of the system, wood can be cut at any time, but foliage may need to be removed before processing it further, depending on the application. The wood is then processed into chips, flakes, or some other particulate format before being used to produce pulp and paper, composite panels or bioenergy.

To produce pulp and paper, mimosa is used as a conventional hardwood substitute, because it has similar fiber properties to common hardwood species. Therefore, it is useful in the production of fine quality paper. Mimosa wood is chipped and fed into existing pulp mills to produce pulp. Most of these mills use the conventional Kraft pulping process. However, other pulping processes, such as mechanical pulping, and chemi-mechanical pulping can also be used. Mimosa is used alone, or mixed with other hardwood or softwood material, before or after pulping. When used alone, mimosa requires less energy and less chemicals to pulp than typical hardwoods, and less bleach to obtain equivalent brightness.

### EXAMPLES

The following examples are provided to further illustrate the present invention and are not intended to limit the invention beyond the limitations set forth in the appended claims.

### Example 1

### Field Studies with Mimosa

Field research with mimosa was conducted near Montgomery in Alabama. Average annual rainfall at the site is about 1,400 mm, and distribution of rainfall is fairly even throughout the year. However, short droughts are common in the hot summer months. Winters are damp with frequent frosts. In 1989 mimosa was planted in four 3×6 m plots with rows 0.90 m apart and plants 0.45 m apart within rows. In 1995, two 0.8 ha plots were seeded using a regular row crop planter with a sorghum seed plate and rows set 1.8 m apart. Seed was obtained from wild plants, and did not represent any improved strains. Seed was scarified with hot water prior to planting, but it was not inoculated with rhizobium.

From 1991 to 1995 all the foliage from the small plots was harvested every 6 weeks to determine forage production and quality. In addition, all the foliage from four replicate plants was harvested by hand every 4, 6, 8, 10 and 12 weeks to determine the effect of harvest interval on forage yield and quality. In May, 2001, samples of young shoots typical of what deer select were also collected from mature mimosa trees, and from young coppice growth originating from plants that had been cut in winter.

Starting in 1996, all plants in each of the small plots were harvested annually in autumn to a stump height of 0.30 m to determine total biomass yield. In 2000, sections of the 0.8-ha fields that had been allowed to grow for one, two or three years were sub-sampled to estimate total biomass yield. No fertilizer was applied to either set of plots. Cattle were also released into the larger plots to consume the foliage.

Total forage or biomass yields from the small plots were determined by harvesting and weighing the relevant material from the two internal rows of the 4-row plots. This material was then sub-sampled and dried to constant weight in order to calculate yield on a dry matter basis. In 1999, sub-samples were separated into leaf and stem to determine the relative proportion of these two components. Forage was also analyzed for crude protein concentration and digestibility. Total rainfall from April to October was 866, 644, 624 and 582 mm in 1996, 1997, 1998 and 1999, respectively.

From 1992 to 1995 forage yield from the small plots averaged 10 Mg/ha of dry matter annually, and was remarkably consistent across years, despite a large variation in rainfall (between April and October, rainfall ranged from 430 to 730 mm across the four years). These high yields were unexpected, especially in view of the fact that the plots received absolutely no fertilizer. This remarkable ability of mimosa to provide high yields without fertilizer and with low rainfall could be related to several factors, including a very extensive root system, and closure of its leaflets at night, which could reduce loss of carbon. Crude protein content was mostly over 20%, and digestibility averaged over 65%. Excavation of mimosa roots indicated prolific nodulation to a depth of 45 cm, which is considerably deeper than for most forage legumes. This nodulation suggested effective nitrogen fixation, and explains the high protein content. In addition, mimosa bark contains numerous small lesions called lenticels, which may be involved in nitrogen fixation from the atmosphere. A relatively high nitrogen content of the bark supported this possibility. Finally, the removal of the surface skin of mimosa bark revealed that a bright green color, suggesting the presence of chlorophyll and photosynthetic activity in the stem, as well as in the leaves. This too, could contribute to the high yield capability of the plant.

Forage quality data for different defoliation intervals are presented in Table 1. Alfalfa is generally considered the best quality forage for livestock, and it is therefore used as a standard for comparison. Typically, crude protein and in vitro dry matter digestibility (IVDMD) values for good quality alfalfa are 20-25% and 70-75%, respectively. However, these values usually decrease sharply with age, even for alfalfa, to less than 15 and 65%, respectively, after 12 weeks.

TABLE 1
Crude Protein (CP), Neutral Detergent Fiber (NDF), Acid Detergent Fiber (ADF),
Permanganate Lignin (PL), and in vitro Dry Matter Digestibility (IVDMD) for 4-, 6-,
8-, 10-, and 12-week defoliation intervals applied to individual Mimosa trees from
1992-1993.
Mimosa Leaf Quality (Means from Tukey's Variation Group)

| Defoliation | Date of | CP | NDF | ADF | PL | IVDMD |
|---|---|---|---|---|---|---|
| Interval | Defoliation | g kg⁻¹ | | | | |
| 4-week | June 1 | 215.21 A | 348.98 C | 256.12 B | 54.56 C | 706.70 A |
| | June 28 | 236.37 A | 269.36 C | 208.62 B | 50.80 C | 746.06 A |
| | July 28 | 243.12 A | 277.03 C | 202.77 B | 50.92 C | 730.90 A |
| | Aug 24 | 246.35 A | 303.13 C | 201.18 B | 53.30 C | 741.93 A |
| | Sept 21 | 239.37 A | 267.36 C | 184.46 B | 51.36 C | 746.48 A |
| 6-week | June 1 | 209.37 B | 352.35 B | 249.92 AB | 67.10 B | 695.95 B |
| | July 12 | 202.71 B | 339.36 B | 231.58 AB | 67.15 B | 696.00 B |
| | Aug 24 | 214.48 B | 342.78 B | 235.70 AB | 74.10 B | 701.18 B |
| | Oct 5 | 244.16 B | 322.40 B | 215.73 AB | 70.26 B | 701.70 B |
| 8-week | June 1 | 220.00 AB | 375.0 AB | 259.02 A | 71.02 AB | 693.08 BC |
| | July 28 | 223.54 AB | 399.67 AB | 260.15 A | 83.35 AB | 644.28 BC |
| | Sept 21 | 220.42 AB | 378.5 AB | 251.52 A | 80.98 AB | 638.10 BC |
| 10-week | June 1 | 182.50 C | 414.0 A | 245.28 A | 80.20 A | 643.32 D |
| | Aug 12 | 184.06 C | 389.3 A | 250.48 A | 87.50 A | 620.08 D |
| | Oct 24 | 197.08 C | 340.0 A | 250.93 A | 89.95 A | 638.83 D |
| 12-week | June 1 | 206.56 B | 395.8 AB | 253.90 A | 88.42 A | 668.83 CD |
| | Aug 24 | 186.25 B | 381.0 AB | 252.42 A | 95.73 A | 643.92 CD |
| | Nov 16 | 237.00 B | 343.2 AB | 228.68 A | 84.18 A | 660.02 CD |

On average, crude protein content of mimosa was 23.6% and 21.0% for the 4- and 12-week defoliation intervals, respectively (see Table 1). Corresponding values for IVDMD were 73.5% and 65.7%, respectively. Crude protein content of young shoots that resemble what deer would select were 33% for mature trees, and 42% for young coppice growth. This indicates that nutritive quality of mimosa foliage is equal or higher than that of alfalfa, which is an extremely surprising result. In addition, unless alfalfa in the southeastern USA is sprayed regularly with insecticides, insect damage is usually severe. However, without use of any insecticides at all, no insect damage was observed on mimosa. Again, it is extremely unusual for a plant to produce foliage of such high nutrutuve quality, but to be resistant to insects. This suggests that mimosa contains some insecticidal compound that does not impair nutritive quality.

Cattle released into the 0.8-ha fields in autumn readily consumed mimosa leaves, and were able to reach even the highest leaves by pushing the stems over. Due to their flexibility, few stems were broken. Yet again, this was a surprising result, and demonstrated that the space well above the normal reach of cattle can be used to produce and store forage, but this forage is still accessible to animals. Observations indicated that virtually no forage was trampled or fouled by excreta, and less than 10% was wasted.

Prior to utilization by cattle there was evidence of heavy browsing of leaves by deer to a height of just over 1 m, indicating the value of mimosa as a food source for these wild animals. Browsing by deer has subsequently been observed throughout the spring-summer-autumn period every year. Clearly, the very high protein content of mimosa allows deer to consume some feed with a relatively low protein content, and still meet the 17% average protein content required in their diet for optimal growth. Therefore, mimosa is really a high protein supplement for deer.

After a single season, coppice growth ranged from 10 to 30 mm in diameter at the base, and many stems exceeded 4 m in length. Total biomass yield from the small plots was 32.7, 27.8, 35.5 and 53.2 Mg/ha of dry matter in 1996, 1997, 1998, and 1999, respectively, which provided an average of 37.3 Mg/ha. In 1999 89.3% of this material was stem, and 10.7% was leaf. Yield estimates of dry wood only from the one- and two-year-old growth in the 0.8-ha plots with rows 1.8 m apart were 12.6 and 17.8 Mg/ha/year, respectively. The lower yields recorded here were primarily due to the lower plant density (half) compared to the small plots. These levels of production compare favorably with yields reported elsewhere, such as 10-15 Mg/ha/year from willow in the state of New York, 18-26 Mg/ha/year from hybrid poplar in the Pacific Northwest, and 31.4 Mg/ha/year recorded for Leucaena leucocephala in Florida. Production is particularly impressive given that no fertilizer was applied to these plots, and plots were harvested every one or two years.

A weed control test was also conducted to identify effective selective herbicides for establishment of mimosa. Herbicides tested are listed in Table 2.

TABLE 2
Herbicides and application rates.

| | | Application rates (oz/ac) | | | |
|---|---|---|---|---|---|
| Trade Name | Chemical composition | 1 | 2 | 3 | 4 |
| Plateau | Ammonium salt of Imazapic(±-2-[4,5-dihydro-4- | 4.0 | 8.0 | 12.0 | |
| | methyl-4-(1-methylethyl)-5-oxo-1H-imidazol-2-yl]- | | | | |
| | 5-methyl-3 pyridinecarboxylic acid) | | | | |
| Pursuit | DG(Ammonium salt of Imazethapyr(±-2-[4,5- | 1.4 | 2.8 | 5.6 | |
| | dihydro-4-methyl-4-(1-methylethyl)-5-oxo- | | | | |
| | 1H-imidazol-2-yl]-5-ethyl-3-pyridinecaeboxylic | | | | |
| | acid) | | | | |
| Arsenal | AC(Isopropylamine salt of Imazapyr(2-[4,5- | 2.0 | 4.0 | 6.0 | 8.0 |
| | dihydro-4-methyl-4-(1-methylethyl)-5-oxo-1H- | | | | |
| | imidazol-2-yl]-3-pyridinecarboxylic acid) | | | | |
| Oust | (Sulfometuron methyl[Methyl 2-[[[[(4,6- | 2.0 | 3.0 | 4.0 | |
| | dimethyl-2-pyrimidinyl)-amino]carbonyl] | | | | |
| | amino]sulfonyl]benzoate) | | | | |
| Escort | (Metsulfuron methyl[Methyl-2[[[[(4-methoxy- | 0.5 | 1.0 | 1.5 | |
| | 6-methyl-1,3,5-triazin-2-yl)amino]carbonyl] | | | | |
| | -amino]sulfonyl]benzoate) | | | | |
| Milestone | (Azafenedin 2-[2,4-dichloro-5-(2-propynyloxy) | 5.0 | 10.0 | 15.0 | |
| | phenyl]-5,6,7,8-tetrahydro-1,2,4-triazolo[4,3-a] | | | | |
| | pyridin-(2H)-one) | | | | |
| Strongarm | (Diclosulam N-(2,6-dichlorophenyl)-5-ethoxy- | 0.6 | 0.9 | 1.2 | |
| | 7-fluoro[1,2,4]triazolo[1,5-c]pyrimidine-2- | | | | |
| | sulfonamide) | | | | |

Results of this test indicated clearly that Strongarm and Pursuit would be effective selective herbicides for establishment of mimosa in commercial fields (see Table 3).

TABLE 3
Number of plants per plot (Plant #), plant height and stem
diameter of mimosa plants at the end of the 2000 growing
season after treatment with different herbicides before (Pre)
and after (Post) emergence.

| | | | | | | Stem | |
|---|---|---|---|---|---|---|---|
| | | Plant # | | Height (cm) | | diameter (mm) | |
| Herbicide | Rate | PRE | POST | PRE | POST | PRE | POST |
| Plateau | 1 | 15.3 | 19.8 | 23.0 | 16.5 | 7.6 | 8.3 |
| | 2 | 3.5 | 18.3 | 12.5 | 22.8 | 9.8 | 10.3 |
| | 3 | 8.8 | 13.5 | 10.5 | 11.9 | 5.9 | 6.6 |
| Pursuit | 1 | 24.0 | 24.5 | 21.8 | 18.5 | 9.3 | 8.1 |
| | 2 | 21.8 | 25.0 | 38.0 | 28.5 | 11.1 | 10.1 |
| | 3 | 21.0 | 23.5 | 33.8 | 22.8 | 10.6 | 9.1 |
| Oust | 1 | 2.2 | 10.3 | 0 | 0 | 0 | 0 |
| | 2 | 0.3 | 6.0 | 0 | 0 | 0 | 0 |
| | 3 | 0.5 | 0 | 0 | 0 | 0 | 0 |
| Escort | 1 | 0.3 | 0 | 0 | 0 | 0 | 0 |
| | 2 | 0 | 0 | 0 | 0 | 0 | 0 |
| | 3 | 0 | 0.3 | 0 | 0 | 0 | 0 |
| Milestone | 1 | 1.0 | 6.8 | 0 | 0 | 0 | 0 |
| | 2 | 0 | 0.3 | 0 | 0 | 0 | 0 |
| | 3 | 0 | 0 | 0 | 0 | 0 | 0 |
| Strongarm | 1 | 16.5 | 18.0 | 36.0 | 27.8 | 7.9 | 8.3 |
| | 2 | 10.5 | 13.8 | 44.3 | 29.0 | 9.9 | 7.7 |
| | 3 | 17.3 | 19.3 | 48.5 | 28.8 | 9.3 | 8.3 |
| Arsenal | 1 | 5.8 | 5.0 | 0 | 0 | 0 | 0 |
| | 2 | 0 | 0.8 | 0 | 0 | 0 | 0 |
| | 3 | 1.8 | 1.0 | 0 | 0 | 0 | 0 |
| | 4 | 0 | 0.3 | 0 | 0 | 0 | 0 |
| Hand Weeded | | 27.3 | 27.5 | 60.3 | 50.3 | 12.9 | 12.9 |
| No Weeding | | 9.3 | 19.5 | 10.5 | 19.3 | 7.3 | 7.3 |

### Example 2

### Pulp and Paper Making Studies with Mimosa

Mimosa has a high cellulose content and a low lignin content and the fibers are comparable in morphology and characteristics to widely used hardwood fibers for making fine papers. Initial pulping experiments using this raw material have been conducted in the Auburn University Pulp and Paper Processing Laboratories. Cooking aspects, conditions of cooking versus quality of pulp, strength properties of paper and anatomic characteristics of fibers were analyzed. In order to evaluate raw-material quality for pulping and papermaking, comparisons were made between this species and sweet gum (Liquidambar styraciflua L), because this species is one of the most commonly used raw materials for papermaking in the United States. Generally, authors agree in reporting that good strength pulps can be obtained from sweet gum wood.

One-year-old and two-year-old mimosa stems were chipped and screened to obtain thickness between 3 and 7 mm without debarking. Screened chips were then kept in plastic bags and conserved in cold room conditions to avoid moisture loss and deterioration. A cooking sequence was carried out to obtain pulps with kappa number between 18 and 20 for tests of strength properties. The regular kraft pulping process was applied with 30% sulfidity, 5.3 liquor/wood ratio, and a variety of conditions of effective alkali, set point temperature and cooking time. After cooking, the pulps were processed in a pulper for 5 minutes and washed well with water and with the aid of a mild vacuum.

Resulting pulps were evaluated for kappa number, viscosity, and unscreened yield. Beating of screened pulp from gum, one-year-old mimosa and two-year-old mimosa was carried out to develop a beater curve (pulp response to mechanical treatment) and TAPPI standard handsheets were made at different freeness levels. Sheets were then conditioned in a constant temperature/humidity room and tested for selected strength properties. Example pulp quality results, as a function of cooking conditions, are presented in Table 4. Yield for two different cooks of two-year-old mimosa were 41% and 38%, compared to 45% for sweet gum. Surprisingly, mimosa bark was decomposed in the cooking process, thus suggesting that debarking would not be necessary in commercial operations.

TABLE 4
Cooking conditions and resulting kappa numbers and pulp
qualities.

| | E.A. | Cook temp | Cook time | | Viscosity |
|---|---|---|---|---|---|
| | (%) | (C.) | (min) | Kappa # | (cP) |
| Mimosa | 16 | 170 | 60 | 12.7 | 28.5 |
| | 14 | 170 | 60 | 14.4 | 30.8 |
| | 12 | 170 | 50 | 16.7 | |
| Sweet Gum | 18 | 170 | 90 | 16.4 | |
| | 18 | 170 | 75 | 16.7 | |
| | 16 | 170 | 75 | 20.5 | |

Sheet surface characteristics were observed using scanning electron microscopy and compared to sheets made from sweet gum pulp under the same cooking and sheet making conditions. Optical microscopy was also used to obtain characteristics of the mimosa fiber.

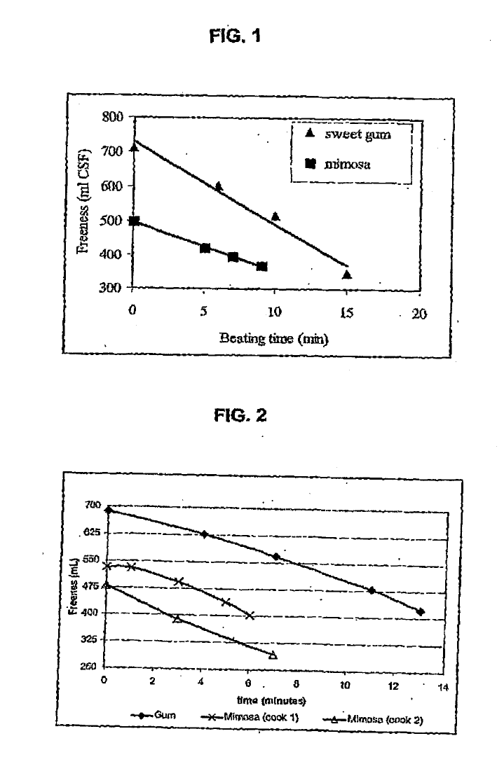

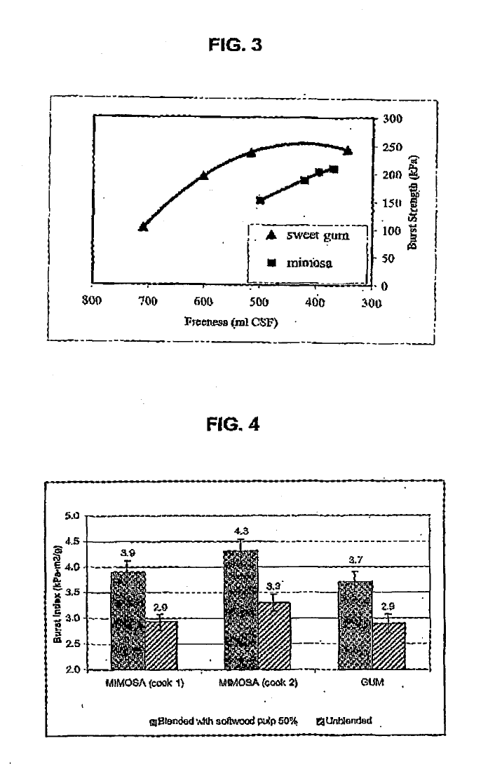

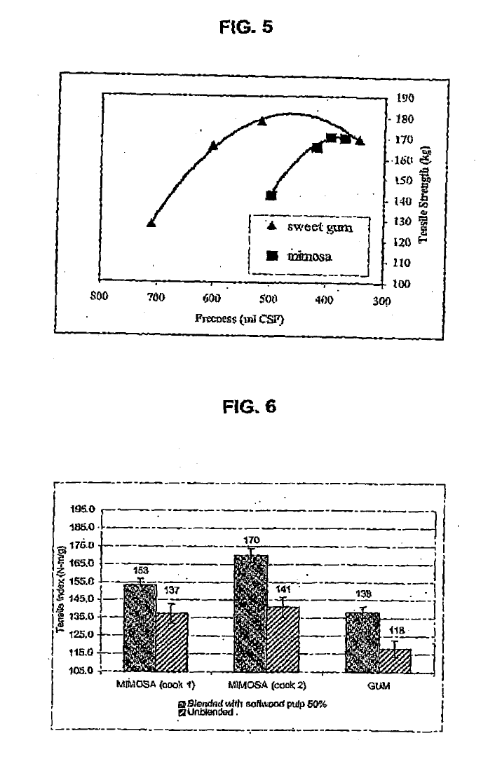

Mimosa had a lower initial freeness than conventional hardwood pulps. Even though the initial beating response was good, subsequent freeness drop was slow, as seen in FIG. 1 and FIG. 2. However, the energy (beating time) required for reaching 400 ml CSF, which is a useful freeness level for bleachable grades of pulp, was less for mimosa pulps compared to gum pulp (five minutes for one-year-old and two minutes for two-year-old mimosa as compared to twelve for sweet gum). This indicates a potential saving of energy in pulp refining. Tensile and bursting strengths for one year old mimosa and sweet gum are comparable at 400 ml CSF (FIG. 3 and FIG. 5) indicating similar bonding characteristics. FIG. 4 and FIG. 6 show that two-year-old mimosa is either equal or superior in strength when compared to gum pulp. When blended with 50% softwood pulp, two-year old mimosa pulps show superior properties compared to gum in tensile and bursting strength.

Fiber length measurement showed that mimosa fibers have an average length of 1.0 mm as compared to gum, which is about 1.6 mm, while fiber diameter of mimosa was in the hardwood range (27 μm). It should be pointed out here that in the initial studies we used only one-year-old mimosa and it is expected that the fiber length will increase with age.

The electron micrographs of one-year-old mimosa and sweet gum at the same magnification showed a similarity in the surface structure, while indicating the collapsible and better bonding potential of the mimosa, even as one-year-old fiber. When given the same chemical bleaching treatment, brightness of pulp from two-year-old mimosa was 86.1 and 85.6%, compared to 84.1% for sweet gum.

1. A method of producing a forage, biomass, composite materials, pulp or paper comprising:
a) planting mimosa to produce mimosa plants; and
b) harvesting said plants to produce a forage or to be used in the production of one member of the group consisting of: biomass, composite materials, pulp and paper.

2. The forage of claim 1, wherein said forage is for livestock feed or deer.

3. The method of claim 1 wherein said planting is planting of mimosa seed.

4. The method of claim 1 wherein said planting consists of plants produced by tissue culture.

5. The method of claim 1, wherein said planting consists of planting stem cuttings.

6. The method of claim 3, wherein said seed is scarified prior to planting.

7. The method of claim 6, wherein said scarification is obtained with hot water, or mechanically scratching the seed coat in order to induce permeability.

8. The process of claim 3, wherein the seed is inoculated with rhizobium bacteria prior to planting in order to induce nodulation and nitrogen fixation.

9. The method of claim 3, wherein said seed is planted by hand.

10. The method of claim 2, wherein said seed is planted with a mechanical planter.

11. The method of claim 9, wherein said seed is planted in containers such as pots, and following germination, mimosa plants are transplanted into deer food plots or commercial fields.

12. The method of claim 11, wherein said mimosa plants are less than 1 foot tall when they are transplanted.

13. The method of claim 11, wherein said mimosa plants are between about 1 foot and about 5 feet tall when they are transplanted.

14. The method of claim 9, wherein said mimosa plants are between about 3 feet and about 5 feet tall when they are transplanted.

15. The method of claim 11, wherein said plants are over 5 feet tall when they are transplanted.

16. The method of claim 10 wherein said seed is planted in rows alternating from about 2 feet apart to about 6 feet apart.

17. The method of claim 10, wherein said seed is planted in rows alternating to more than 6 feet apart.

18. The method of claim 10, wherein said mimosa is planted in solid stands.

19. The method of claim 10, wherein said mimosa is planted in strips, with strips of other typical pasture forages between the mimosa strips.

20. The method of claim 10, wherein said mimosa is planted in clumps or patches, with typical pasture forages between the clumps.

21. The method of claim 3, wherein a selective herbicide such as Strongarm or Pursuit is used to control weeds during establishment of mimosa plants.

22. The method of claim 1, wherein domestic livestock such as cattle, sheep or goats are allowed continuous access to an area following successful establishment of mimosa.

23. The method of claim 1, wherein said mimosa plants are harvested and chopped mechanically to make silage for livestock.

24. The method of claim 1, wherein mimosa biomass is harvested with or without prior removal of foliage by domestic livestock, and processed into bioenergy.

25. The method of claim 24, wherein said mimosa is grown between about 12 months to about 36 months before biomass is harvested.

26. The method of claim 24, wherein said mimosa is grown more than 36 months before biomass is harvested.

27. The method of claim 24, wherein the bioenergy produced is a liquid fuel, such as ethanol, methanol or mixed alcohols.

28. The method of claim 27, wherein the biomass conversion method involves acid hydrolysis and fermentation.

29. The method of claim 27, wherein the biomass conversion method involves enzyme hydrolysis and fermentation.

30. The method of claim 27, wherein the biomass conversion process involves gasification and fermentation.

31. The method of claim 27, wherein the biomass conversion process involves gasification and catalytic conversion to a liquid fuel.

32. The method of claim 24, wherein the bioenergy produced is electricity.

33. The process of claim 32, wherein the electricity is produced by co-firing the mimosa biomass with coal.

34. The method of claim 32, wherein the electricity is produced by gasifying the mimosa biomass in a gasifier, and using syngas from the gasifier to power steam turbines.

35. The method of claim 32, wherein the electricity is produced by gasifying the mimosa biomass and using the syngas from the gasifier to power gas turbines.

36. The method of claim 32, wherein the electricity is produced by gasifying the mimosa biomass, and using the syngas from the gasifier to power an internal combustion engine.

37. The method of claim 1, wherein said mimosa wood is harvested and used to manufacture composite materials.

38. The method of claim 37, wherein the composite materials are composite panels, such as particle board, medium density fiberboard, or oriented strand board.

39. The method of claim 37, wherein the binder for the mimosa particles in the composite material is a plastic, or similar compound.

40. The method of claim 1, wherein mimosa wood is used to produce pulp and paper with or without prior removal of foliage by domestic livestock, and with or without debarking the mimosa prior to pulping.

41. The method of claim 40, wherein said mimosa wood is used alone to produce pulp and paper.

42. The method of claim 40, wherein said mimosa wood is blended with typical hardwood or softwood, prior to pulping.

43. The method of claim 40, wherein pulp from mimosa and pulp from other raw materials are blended after pulping to produce paper.

44. The method of claim 40, wherein said mimosa wood is subject to chemical pulping.

45. The method of claim 40, wherein said mimosa wood is subject to mechanical pulping.

46. The method of claim 40, wherein said mimosa wood is subject to chemi-mechanical pulping.

47. The method of claim 40, wherein said mimosa pulp is subject to chlorine-containing bleach.

48. The method of claim 40, wherein said mimosa pulp is subject to non-chlorine bleach.
